(19) United States
(12) Patent Application Publication
(10) Pub. No.: US 2025/0013247 A1
(43) Pub. Date: Jan. 9, 2025

(54) AUTONOMOUS WORK MACHINE, CONTROL METHOD OF AUTONOMOUS WORK MACHINE, AND STORAGE MEDIUM

(71) Applicant: HONDA MOTOR CO., LTD., Tokyo (JP)

(72) Inventor: Takayuki Sato, Wako-shi (JP)

(73) Assignee: HONDA MOTOR CO., LTD., Tokyo (JP)

(21) Appl. No.: 18/892,922

(22) Filed: Sep. 23, 2024

Related U.S. Application Data
(63) Continuation of application No. PCT/JP2022/014128, filed on Mar. 24, 2022.

(51) Int. Cl. G05D 1/648; G05D 105/15; G05D 107/20

(52) U.S. Cl. CPC G05D 1/6486; G05D 2105/15; G05D 2107/23

(57) ABSTRACT

An autonomous work machine including a working unit, the autonomous work machine comprising: a detection unit configured to detect a rear work target object of the autonomous work machine; a determination unit configured to determine a state of the rear work target object based on a detection result of the detection unit; and a control unit configured to control a travel route of the autonomous work machine based on a determination result of the determination unit.

### CROSS-REFERENCE TO RELATED APPLICATION(S)

This application is a continuation of International Patent Application No. PCT/JP2022/014128 filed on Mar. 24, 2022, the entire disclosures of which is incorporated herein by reference.

### BACKGROUND OF THE INVENTION

### Field of the Invention

The present invention relates to an autonomous work machine, a control method of an autonomous work machine, and a storage medium.

### Description of the Related Art

Patent Literature 1 discloses that necessity of additional work (for example, presence or absence of uncut turf) is determined based on information from a first autonomous work machine, and the additional work is performed manually or by a different second autonomous work machine when the additional work is necessary.

### CITATION LIST

### Patent Literature

PTL 1: Japanese Patent Laid-Open No. 2021-158993

However, the additional work does not occur only when it is difficult to perform the work with the first autonomous work machine, such as cutting at the edge (for example, cutting turf around trees), and the additional work (for example, work on the uncut turf) may occur due to a temporary event, such as stepping down the turf with the tires of the first autonomous work machine itself. In such a case, when the work is performed manually or by the second autonomous work machine, work efficiency may be reduced.

### SUMMARY OF THE INVENTION

The present invention has been made in view of the above problems, and provides a technique for improving work efficiency.

According to one aspect of the present invention, there is provided an autonomous work machine including a working unit, the autonomous work machine comprising: a detection unit configured to detect a rear work target object of the autonomous work machine; a determination unit configured to determine a state of the rear work target object based on a detection result of the detection unit; and a control unit configured to control a travel route of the autonomous work machine based on a determination result of the determination unit.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain principles of the invention.

FIG. 1 is an external diagram of a work machine capable of autonomously traveling according to an embodiment of the present invention.

FIG. 2 is a configuration diagram illustrating the work machine according to the embodiment of the present invention as viewed from a side.

FIG. 3 is a block diagram illustrating a relationship between input and output of an electronic control unit (ECU) that controls the work machine according to the embodiment of the present invention.

FIG. 4 is a flowchart illustrating a procedure of processing performed by a work machine according to a first embodiment.

FIG. 5 is a diagram illustrating an example of a work area and a travel route according to the embodiment of the present invention.

FIG. 6 is a diagram illustrating an example of a teacher image according to the first embodiment, and a diagram illustrating an example of a photographed image according to the first embodiment.

FIG. 7 is an explanatory diagram of rework in the work area according to the embodiment of the present invention.

FIG. 8 is a flowchart illustrating a procedure of processing performed by a work machine according to a second embodiment.

FIG. 9 is an explanatory diagram of laser scanning according to the second embodiment.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

### Configuration

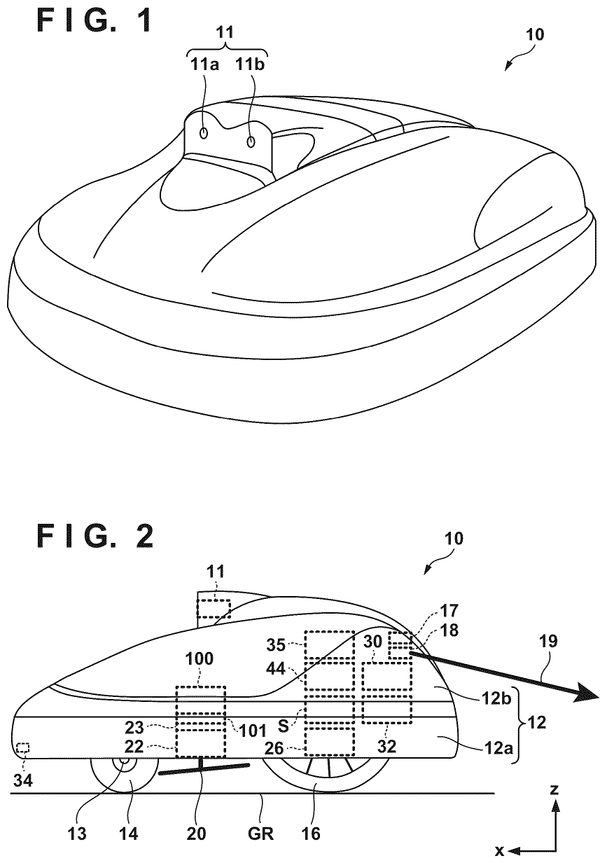

FIG. 1 is an external diagram of an autonomous work machine capable of autonomously traveling according to an embodiment of the present invention. Hereinafter, a moving direction (vehicle length direction), a lateral direction (vehicle width direction) orthogonal to the moving direction, and a vertical direction orthogonal to the moving direction and the lateral direction of the work machine in a side view are respectively defined as a front-and-rear direction, a left-and-right direction, and an up-and-down direction, and the configuration of each part will be described in accordance with the above definition.

In FIG. 1, reference numeral 10 indicates a work machine (hereinafter, referred to as a “work vehicle”). Specifically, a work vehicle 10 functions as a lawn mower that autonomously travels. However, the lawn mower is an example, and the present invention can also be applied to other types of work machines (for example, a floor cleaner, a snow blower, a cultivator, or the like). The work vehicle 10 includes a front camera unit 11 including a plurality of cameras (a first camera 11a and a second camera 11b), and can calculate and acquire distance information between an object existing in front and the work vehicle 10 using images photographed by the first camera 11a and the second camera 11b having parallax.

FIG. 2 is a diagram illustrating the work vehicle 10 observed in the lateral direction (vehicle width direction). As illustrated in FIG. 2, the work vehicle 10 includes the front camera unit 11, a vehicle body 12, a stay 13, front wheels 14, rear wheels 16, a rear camera unit 17, a laser irradiation unit 18, a blade 20, a work motor 22, a motor holding member 23, a blade-height adjustment motor 100, and a translation mechanism 101. The work vehicle 10 further includes travel motors 26, a group of various sensors S, an electronic control unit (ECU) 44, a charging unit 30, a battery (battery) 32, a charging terminal 34, and a notification unit 35.

The vehicle body 12 of the work vehicle 10 has a chassis 12a and a frame 12b attached to the chassis 12a. The front wheels 14 include one left wheel and one right wheel each having a smaller diameter and fixed to the front of the chassis 12a via the stay 13 in the front-and-rear direction. The rear wheels 16 include one left wheel and one right wheel each having a larger diameter and attached to the rear of the chassis 12a.

The rear camera unit 17 is a camera unit that photographs the rear of the work vehicle 10 and acquires a photographed image. A state of a rear work target object is determined by comparing the photographed image with a teacher image registered in advance. For example, the photographed image of the rear work target object photographed at an arbitrary position in a work area is compared with a teacher image (that is, a photographed image photographed by the work vehicle 10 after work is cleanly executed without leaving any uncut part) registered in advance at the position. Distribution of luminance values of the work target object (for example, vegetation such as turf) after the work is cleanly executed without uncut part is uniform, but when there is unevenness in cutting, a portion with a dark color and a portion with a light color are formed, so that the distribution of the luminance values becomes non-uniform. Therefore, the state (a state in which rework is necessary because there is an uncut part, or a state in which rework is unnecessary because there is no uncut part) of the rear work target object can be determined by comparing the distribution of the luminance values.

The laser irradiation unit 18 can scan a rear work target object of the vehicle in a horizontal direction (left-and-right direction) and irradiate the work target object with a laser. In the illustrated example, scanning can be performed in the horizontal direction (for example, the left-and-right direction) while maintaining a direction of an arrow 19 which is a direction at a predetermined angle with respect to a ground surface GR. The state of the rear work target object is determined by analyzing the laser irradiation result. By irradiating a laser in the horizontal direction, it is possible to calculate and acquire uniformity of a height of the work target object at a predetermined distance from the laser irradiation unit 18. Therefore, it is possible to determine the state of the rear work target object (the state in which rework is necessary because there is an uncut part, or the state in which rework is unnecessary because there is no uncut part) based on the laser irradiation result.

In the present embodiment, a configuration in which the work vehicle 10 includes both the rear camera unit 17 and the laser irradiation unit 18 has been exemplified. However, as long as one of the rear camera unit 17 and the laser irradiation unit 18 is provided, the state of the rear work target object can be determined, and only one of the rear camera unit 17 and the laser irradiation unit 18 may be provided.

The blade 20 is a rotary blade for mowing work and is attached near a central position of the chassis 12a. The blade 20 is a working unit according to the present embodiment, and functions as a cutting unit for cutting vegetation such as turf.

The work motor 22 is an electric motor disposed above the blade 20. The blade 20 is connected to the work motor 22, and is rotatably driven by the work motor 22. The motor holding member 23 holds the work motor 22. The motor holding member 23 is restricted in rotation with respect to the chassis 12a, and is allowed to move in the up-and-down direction by, for example, a combination of a guide rail and a slider that is guided by the guide rail and is movable up and down.

The blade-height adjustment motor 100 is a motor for adjusting a height of the blade 20 in the up-and-down direction with respect to the ground surface GR. The translation mechanism 101 is connected to the blade-height adjustment motor 100, and is a mechanism for converting rotation of the blade-height adjustment motor 100 into translation in the up-and-down direction. The translation mechanism 101 is also connected to the motor holding member 23 that holds the work motor 22.

The rotation of the blade-height adjustment motor 100 is converted into the translation (movement in the up-and-down direction) by the translation mechanism 101, and the translation is transmitted to the motor holding member 23. Due to the translation (movement in the up-and-down direction) of the motor holding member 23, the work motor 22 held by the motor holding member 23 is also translated (moves in the up-and-down direction). Due to the movement of the work motor 22 in the up-and-down direction, the height of the blade 20 with respect to the ground surface GR can be adjusted.

The travel motors 26 are two electric motors (prime movers) attached to the chassis 12a of the work vehicle 10. The two electric motors are connected one-to-one to the left and right rear wheels 16. By independently rotating the left and right wheels forward (rotating in a forward direction) or backward (rotating in a backward direction) with the front wheels 14 as driven wheels and the rear wheels 16 as driving wheels, the work vehicle 10 can be moved in various directions.

The charging terminal 34 is a charging terminal provided at a front-end position of the frame 12b in the front-and-rear direction, and is connected to the corresponding terminal of a charging station (not illustrated) to receive power supplied from the charging station. The charging terminal 34 is connected to the charging unit 30 via wiring, and the charging unit 30 is connected to the battery (battery) 32. In addition, the work motor 22, the travel motor 26, and the blade-height adjustment motor 100 are connected to the battery 32, and are supplied with power from the battery 32.

The ECU 44 is an electronic control unit including a microcomputer formed on a circuit board and controls an operation of the work vehicle 10. Details of the ECU 44 will be described below. When an abnormality has occurred in the work vehicle 10, the notification unit 35 notifies information indicating that an abnormality has occurred and notifies information on the state of the work target object. For example, the notification can be given with voice or display. Alternatively, by outputting information to an external device (information processing device) connected to the work vehicle 10 in a wired or wireless manner, the information can be notified via the external device (information processing device).

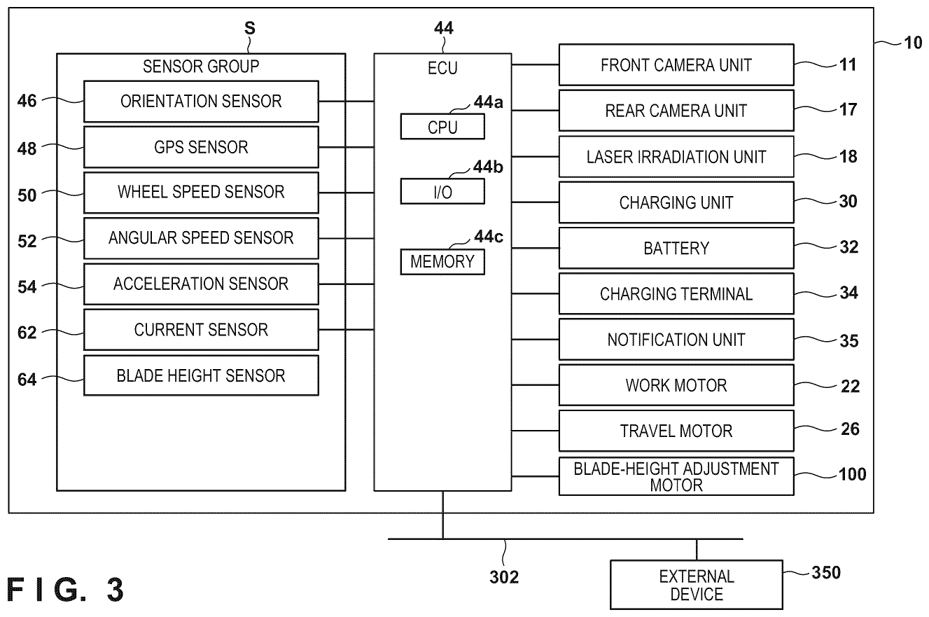

FIG. 3 is a block diagram illustrating a relationship between input and output of the electronic control unit (ECU) that controls the work vehicle 10. As illustrated in FIG. 3, the ECU 44 includes a CPU 44a, an I/O 44b, and a memory 44c.

The CPU 44a is one or more central processing units and executes various operations. The I/O 44b is an input/output interface with various components. Furthermore, the I/O 44b can function as a communication interface, and can be connected to an external device (for example, an information processing device such as a server device) 350 in a wired or wireless manner via a network 302.

The memory 44c is one or more storage media such as a read only memory (ROM), an electrically erasable programmable read only memory (EEPROM), a random access memory (RAM), or the like. The memory 44c stores various programs for controlling the operation of the work vehicle 10. In order to operate each processing unit for realizing the present invention, the ECU 44 reads and executes a program stored in the memory 44c.

The ECU 44 is connected to the group of various sensors S. The sensor group S includes an orientation sensor 46, a GPS sensor 48, a wheel speed sensor 50, an angular speed sensor 52, an acceleration sensor 54, a current sensor 62, and a blade height sensor 64.

The orientation sensor 46 and the GPS sensor 48 are sensors for acquiring information on a position and an orientation of the work vehicle 10. The orientation sensor 46 detects an orientation in accordance with geomagnetism. The GPS sensor 48 receives a radio wave from a GPS satellite and detects information indicating a current position (latitude and longitude) of the work vehicle 10. Thus, the position of the work vehicle 10 can be estimated.

The wheel speed sensor 50, the angular speed sensor 52, and the acceleration sensor 54 are sensors for acquiring information regarding a moving state of the work vehicle 10. The wheel speed sensor 50 detects wheel speeds of the left and right rear wheels 16. The angular speed sensor 52 detects an angular speed around an axis in the up-and-down direction (z axis in the vertical direction) of a gravity center position of the work vehicle 10. The acceleration sensor 54 detects accelerations in three orthogonal axis directions of x, y, and z axes acting on the work vehicle 10.

The current sensor 62 detects current consumption (an amount of power consumption) of the battery 32. A detection result of the current consumption (the amount of power consumption) is stored in the memory 44c of the ECU 44. In a case where a predetermined amount of power is consumed and an amount of power stored in the battery 32 becomes equal to or less than a threshold, the ECU 44 controls the work vehicle 10 to return to the charging station (not illustrated) for charging.

The blade height sensor 64 detects a height of the blade 20 with respect to the ground surface GR. The detection result of the blade height sensor 64 is output to the ECU 44. Based on the control of the ECU 44, the blade-height adjustment motor 100 is driven and the blade 20 moves up and down in the up-and-down direction to adjust the height from the ground surface GR.

Outputs of the group of various sensors S are input to the ECU 44 via the I/O 44b. Based on the outputs of the group of various sensors S, the ECU 44 supplies power from the battery 32 to the travel motor 26, the work motor 22, and the height adjustment motor 100. The ECU 44 controls the traveling of the work vehicle 10 by outputting a control value via the I/O 44b and controlling the travel motor 26. In addition, the height of the blade 20 is adjusted by outputting the control value via the I/O 44b and controlling the height adjustment motor 100. Further, the ECU 44 outputs the control value via the I/O 44b to control the work motor 22, so as to control the rotation of the blade 20.

### Processing

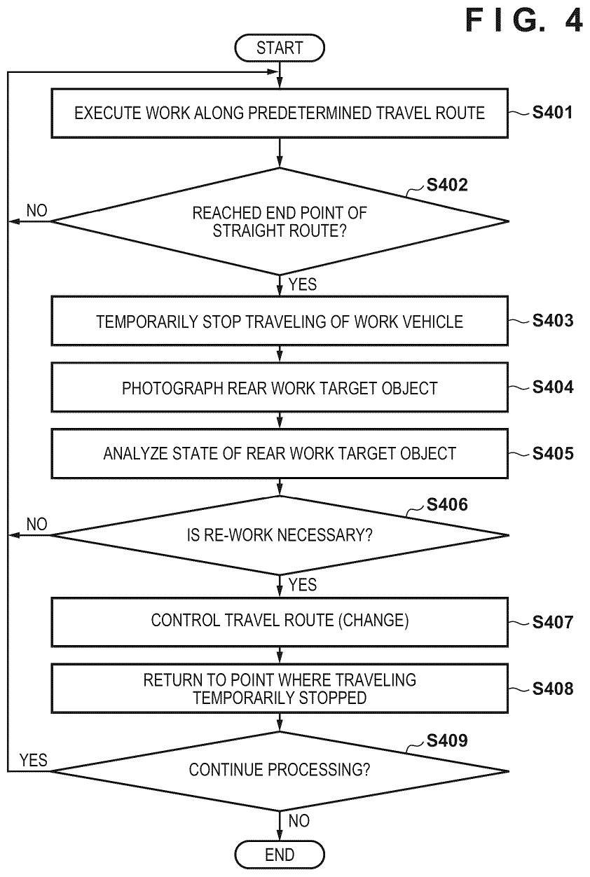

Next, a procedure of processing performed by the work vehicle 10 according to the present embodiment will be described with reference to a flowchart of FIG. 4. In the present embodiment, an example of determining a state of a rear work target object of the work vehicle 10 using the rear camera unit 17 will be described.

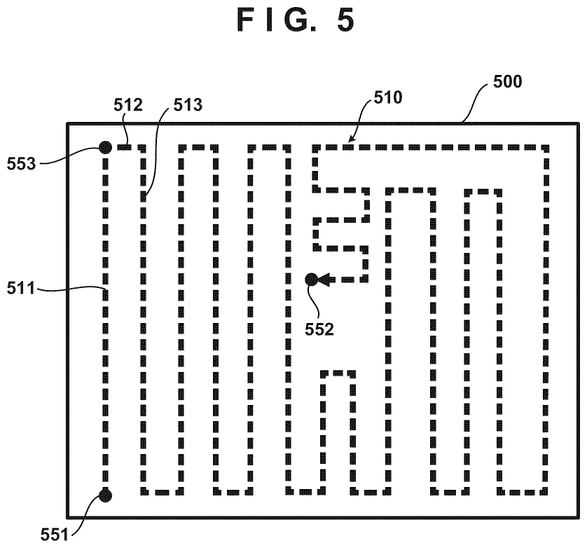

In step S401, the ECU 44 executes work along a predetermined travel route. Here, FIG. 5 is a diagram illustrating an example of a travel route in a work area according to the present embodiment. The work according to the present embodiment is work of cutting vegetation such as turf and uniformly adjusting the vegetation such that the entire vegetation has a constant height. The work vehicle 10 performs work while moving along a predetermined travel route 510 in a work area 500. The predetermined travel route 510 includes a plurality of straight routes 511, 512, 513, . . . . In the illustrated example, the work is started from a start point 551, and the work is ended when an end point 552 is reached.

In step S402, the ECU 44 determines whether an end of a straight route portion of the predetermined travel route has reached. In the example of FIG. 5, in the predetermined travel route 510, for example, the work is started from the start point 551, and it is determined whether the end point 553 of the straight route 511 has reached. In a case where this step is Yes, the processing proceeds to S403. On the other hand, in a case where this step is No, the processing returns to step S401.

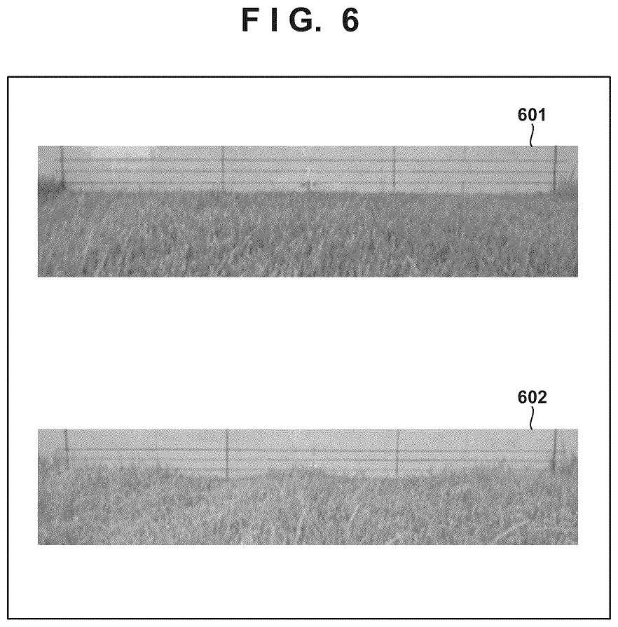

In step S403, the ECU 44 temporarily stops traveling of the work vehicle 10. In step S404, the ECU 44 uses the rear camera unit 17 to photograph a rear work target object (for example, vegetation such as turf) of the work vehicle 10 and acquires a photographed image. In the example of FIG. 5, for example, a work target object in a direction from the end point 553 to the start point 551 is photographed. An image 602 in FIG. 6 is an example of the photographed image. In step S405, the ECU 44 analyzes a state of the rear work target object. For example, luminance distribution of the rear photographed image acquired in step S404 is analyzed.

In step S406, the ECU 44 determines whether rework on the rear work target object is necessary. For example, the luminance distribution of the rear photographed image acquired in step S404 is compared with luminance distribution of a teacher image (that is, a teacher image when vegetation as a work target object is in a state of a specific height) registered in advance in association with a position at the time of photographing in step S404, and a difference therebetween (a degree of non-uniformity of the rear work target object) is analyzed. Here, an image 601 of FIG. 6 is an example of the teacher image corresponding to the same position as the image 602. When the difference in the luminance distribution is equal to or greater than a threshold, it is determined that rework on the rear work target object is necessary (here, non-uniform state with an uncut part and unevenness), and when the difference is less than a threshold, it is determined that rework on the rear work target object is unnecessary (here, uniform state without an uncut part and unevenness).

In a case where it is determined that rework is not necessary, the processing returns to step S401 and the work is continued along the predetermined travel route. For example, a turning operation is performed while the work is executed at the end point 553, and the work shifts to a next work on the straight route 512. Thereafter, the same operation is repeated. On the other hand, when it is determined that rework is necessary, the processing proceeds to step S407.

In step S407, the ECU 44 controls the travel route of the work vehicle 10 for rework. Specifically, the travel route is controlled based on the position of the work vehicle 10 at the time of photographing and the position of the rear work target object. More specifically, the travel route is changed such that the work vehicle 10 executes work again on the rear work target object. As an example, the travel route is changed by moving the work vehicle 10 backward. By executing the rework while moving the work vehicle backward, the work can be performed again on the rear work target object for which the work has been insufficient. At this time, instead of moving the work vehicle backward along the traveling straight route as it is, the position of the work vehicle 10 may be shifted by a predetermined amount in the lateral direction to move the work vehicle 10 backward. As a result, for example, when work is not successfully performed due to a work target object being stepped down by the front wheel 14 and the rear wheel 16 of the work vehicle 10, it is possible to successfully execute rework on such a work target object.

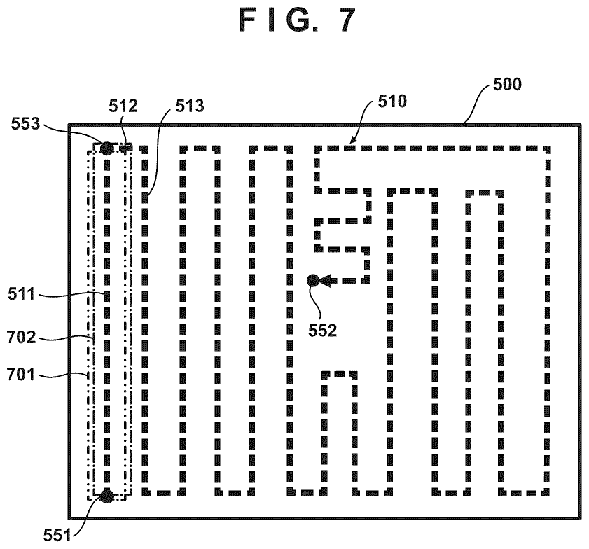

For the same purpose, the travel route may be changed such that the work vehicle 10 works on a work target object in a worked area including at least a part of the rear work target object and a work target object in an unworked area where the work vehicle 10 has not performed work. For example, the travel route may be changed such that work is performed on a work target object in a worked area 701 (that is, an area where the work vehicle 10 has traveled and performed work) illustrated in FIG. 7 and a work target object in an unworked area (an area other than the work area 701) where the work vehicle 10 has not performed work. In the illustrated example, for example, control may be performed so as to travel in the work area 702 shifted in the lateral direction with respect to the work area 701, and the work may be executed while moving the work vehicle backward from the end point 553 to the start point 551. As a result, for example, when work is not successfully performed due to a work target object being stepped down by the front wheel 14 and the rear wheel 16 of the work vehicle 10, it is possible to successfully execute rework on such a work target object.

When the work is performed while moving the work vehicle backward, a traveling speed of the work vehicle 10 may be changed to a lower speed. As a result, work unevenness is less likely to occur, and more accurate work can be realized.

In step S408, the ECU 44 moves the work vehicle 10 so as to return to the point where traveling is temporarily stopped in step S403. In the examples of FIGS. 5 and 7, when the work vehicle is moved backward on the straight route 511 from the end point 553 to the start point 551 to perform rework, the work vehicle 10 is moved forward along the straight route 511 from the start point 551 to the end point 553.

In step S409, the ECU 10 determines whether to continue a series of processing. For example, in a case where the work on the entire predetermined travel route 510 is completed, that is, in a case where the end point 552 has reached, it is determined to end the processing. Alternatively, in a case where an event such as failure or battery exhaustion occurs on the way, the processing may be ended. In a case where the processing ends, control to return to the charging station (not illustrated) may be performed. In a case where it is determined that the series of processing is continued, the processing returns to step S401, and the work along the predetermined travel route is continued. In contrast, in a case where it is determined to end the series of processing, the processing ends. This is the end of the processing of the flowchart of FIG. 4.

As described above, in the present embodiment, a rear work target object of the autonomous work machine is detected by photographing, and a state of the rear work target object is determined based on the detection result. Then, a travel route of the autonomous work machine is changed based on the determination result. As a result, work can be continued when the rear work target object is sufficiently worked, and rework can be performed when the work is insufficient.

In this way, by changing the travel route according to the state of the work target object, a same work machine can redo work on the work target object, so that work efficiency can be improved.

### Modifications

In the processing of FIG. 4, an example has been described in which work is executed along a predetermined travel route in step S401, and when an end point of the straight route is reached, traveling is temporarily stopped, and a rear work target object is photographed to analyze a state of the work target object. However, the present invention is not limited to this example. For example, while the work is executed along the predetermined travel route in step S401, the rear work target object may be photographed and analyzed in step S404 in parallel (continuously) to determine necessity of rework. When it is determined that rework is necessary, the traveling may be temporarily stopped at the point where it is determined that rework is necessary and the work vehicle may be controlled to move backward for the rework even in the middle of traveling on the straight route.

Alternatively, work may be advanced along a predetermined travel route while sequentially storing a position of the point where it is determined that rework is necessary, and when the work of a predetermined range ends, the work may be returned to the point where rework is necessary to perform the rework. In this case, when returning to the point where rework is necessary, only traveling may be performed without performing rework, and the rework may be performed pinpointed at the necessary point. Here, the time after the end of the work within the predetermined range may be, for example, after the end point 552 is reached.

### Second Embodiment

In the first embodiment, an example of determining a state of the rear work target object of the work vehicle 10 using the rear camera unit 17 has been described. On the other hand, in the present embodiment, an example of determining the state of the rear work target object of the work vehicle 10 using the laser irradiation unit 18 will be described. Since a configuration of the work vehicle 10 is similar to the configuration described in the first embodiment, a detailed description thereof will be omitted.

### Processing

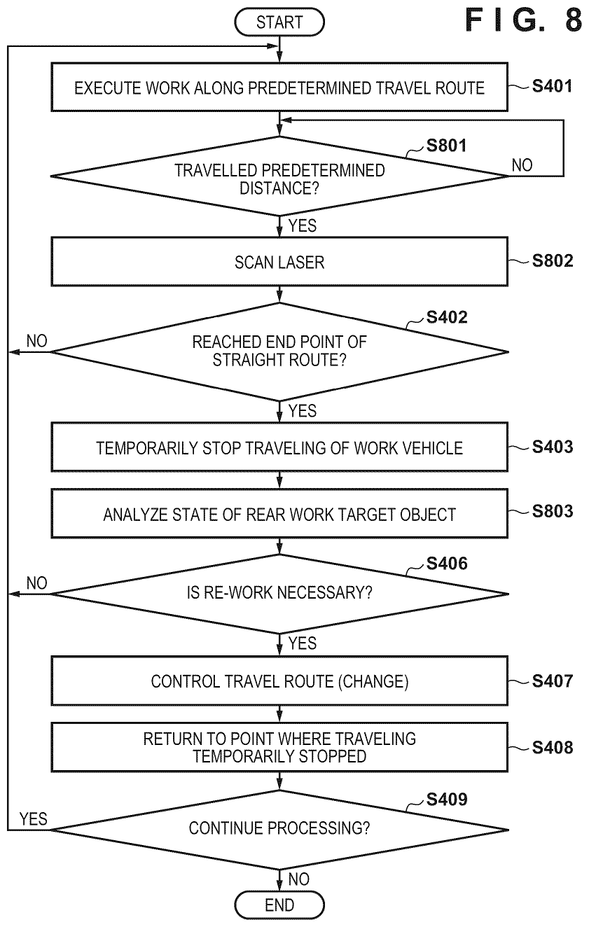

A procedure of processing performed by the work vehicle 10 according to the present embodiment will be described with reference to a flowchart of FIG. 8. Processing similar to those in the flowchart of FIG. 4 are denoted by the same reference signs, and the description thereof will be omitted.

In step S801, the ECU 44 determines whether the work vehicle has traveled a predetermined distance (for example, 50 cm) while executing work. In the example of FIG. 5, for example, when the work vehicle is traveling on the straight route 511 of the predetermined travel route 510, it is determined whether the work vehicle has moved forward by the predetermined distance. In a case where the work vehicle has traveled the predetermined distance, the processing proceeds to step S802. When the work vehicle has not traveled the predetermined distance, it waits until the work vehicle travels the predetermined distance.

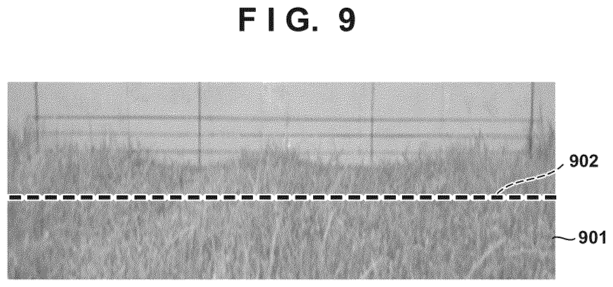

In step S802, the ECU 44 scans a laser in the horizontal direction by using the laser irradiation unit 18, and irradiates a rear work target object (for example, vegetation such as turf) of the work vehicle 10 with a laser. An irradiation range of the laser can be wider than a size of a working unit (for example, a rotation operation range of the blade 20 as the cutting unit). As an example, an image 901 of FIG. 9 indicates the rear work target object, and a laser 902 is scanned in the horizontal direction (for example, from a left end to a right end) to acquire a laser irradiation result.

After the laser is scanned in step S802, the processing returns to step S401 through the determination processing in step S402, and the same operation is repeated until the end point of the straight route is reached. By repeating this processing, it is possible to acquire information for determining the state of the rear work target object at predetermined intervals on the straight route.

In step S803, the ECU 44 analyzes the state of the rear work target object. In the present embodiment, the state of the work target object is determined based on the laser irradiation result acquired for each predetermined distance. As illustrated in FIG. 9, when a work target object exists at an irradiation destination of the laser that irradiates a point at a certain distance at the rear of the work vehicle 10, a reflection result of the irradiated laser can be acquired, but when a work target object does not exist, the reflection result cannot be acquired. When a portion where the work target object exists and a portion where the work target object does not exist are obtained by scanning the laser in the horizontal direction, it can be determined that work on the work target object is insufficient (there is unevenness in the work) because the height has unevenness. When the work target object exists in all the portions, it may be determined that work is insufficient as a whole. This may be a case, for example, when the working unit (for example, the blade 20) has a defect and work cannot be performed well (for example, when the blade is worn and cannot cut well).

Then, for example, when a proportion of the portion where the work target object does not exist in a scanning length in the horizontal direction (for example, a length from the left end to the right end of the laser 902 in FIG. 9) is a predetermined proportion (for example, 80%) or more, it can be determined that work on the work target object is sufficient (there is no unevenness in the work). As a result, it is possible to determine whether work is sufficiently performed at predetermined intervals. When there are a position where work is sufficient and a position where work is insufficient even on the same straight route, the work may be executed only in the vicinity of the insufficient position. That is, by configuring the blade 20 to be rotationally driven only near the insufficient position, the battery (battery) 32 can be held for a long time.

Since the laser scanning is performed every time the work vehicle 10 moves forward by a predetermined distance, it may be determined that the work on the work target object is sufficient (there is no unevenness in the work) when the proportion of the portion where the work target object does not exist in a total scanning length of a plurality of times of scanning is a predetermined proportion (for example, 80%) or more. The other processing is similar to those of the first embodiment.

As described above, the rear work target object of the autonomous work machine is detected by laser scanning, and the state of the rear work target object is determined based on the detection result. Then, a travel route of the autonomous work machine is changed based on the determination result. As a result, work can be continued when the rear work target object is sufficiently worked, and rework can be performed when the work is insufficient.

In this way, by changing the travel route according to the state of the work target object, a same work machine can redo work on the work target object, so that work efficiency can be improved.

### Modifications

In each of the above embodiments, an example has been described in which when work is insufficient, rework is executed while moving backward. However, the rework is not limited to the case of performing the rework while moving the work vehicle backward, and the work vehicle 10 may be moved backward without performing rework from a second end point to a first end point of the straight route constituting a part of the travel route. After returning to the first end point, the work vehicle 10 may be moved forward again to perform the rework. Alternatively, the rework may be executed both when moving the work vehicle backward and when moving the work vehicle forward again.

Further, in each of the above embodiments, the example in which the vehicle travels to the next straight route after executing the rework once has been described. However, after returning to the point where the traveling is temporarily stopped in the processing of step S408, it may be determined again whether rework is necessary as in step S406. When it is determined that a second rework is further required after a first rework is executed, change contents of the travel route in step S407 may be adjusted. For example, when the work vehicle 10 is shifted rightward by a predetermined distance with respect to a center position of the travel route to perform rework for the first time, the work vehicle 10 may be shifted leftward by a predetermined distance with respect to the center position of the travel route to perform rework for the second time. As a result, since a traveling position at the time of rework changes, it is possible to increase a possibility that the work is determined to be sufficient by the second rework.

Further, when it is determined that the second rework is further required after the first rework is executed, it may be notified that the work cannot be performed well. For example, information indicating that manual work is necessary or information indicating that replacement of the working unit (for example, the blade 20) is necessary may be notified. As a result, it is possible for a user to recognize and cope with work defects at an early stage.

The notification can be performed using the notification unit 35 of the work vehicle 10. When the work vehicle 10 includes a display, information indicating it may be displayed on the display, or notification may be performed by voice. Alternatively, in a case where the external device 350 is a communication device possessed by the user, notification may be performed by transmitting information to the external device 350. In a case where the external device 350 is a server device, information may be transmitted to the server device, and the information may be transmitted to the communication device possessed by the user via the server device to be notified.

Alternatively, the notification may not be given after the first rework, and may be given only when the work is insufficient again after the second rework. This makes it possible to suppress excessive notification.

In each of the above embodiments, an example in which the work vehicle 10 executes all the series of processing has been described, but the present invention is not limited to this example. For example, after the work vehicle 10 detects a rear work target object (by photographing or laser scanning), the detection result may be transmitted to the external device 350 (an information processing device such as a server device), and the external device 350 may determine the state of the rear work target object of the work vehicle 10 based on the detection result. The work vehicle 10 may receive the determination result of the state by the external device 350 from the external device 350, and the travel route of the work vehicle may be changed based on the determination result received by the work vehicle 10. As a result, a processing load of the work vehicle 10 can be reduced.

In the first embodiment, an example in which a state determination is performed using luminance distribution of an image has been described, but the state determination may be performed based on a color density (for example, when there is an uncut part, a color of vegetation becomes dark, and when a cut portion is uniformly cut, a color density becomes the same as a whole) of the work target object in the image.

According to the present invention, by controlling a travel route according to a state of a work target object, a same work machine can redo work on the work target object, so that work efficiency can be improved.

### Summary of Embodiments

1. The autonomous work machine according to the above embodiments is an autonomous work machine (10) including working means (20), the autonomous work machine comprising:
detection means (17, 18, 44) for detecting a rear work target object of the autonomous work machine;
determination means (44) for determining a state of the rear work target object based on a detection result of the detection means; and
control means (44) for controlling a travel route of the autonomous work machine based on a determination result of the determination means.

As a result, it is possible to perform control such that work is continued when the rear work target object is sufficiently worked, and the work is returned and rework is performed when the work is insufficient. As described above, by controlling the travel route according to the state of the work target object, it is possible to redo the work on the work target object by one work machine. Therefore, it is not necessary to use another type of work machine, and work efficiency can be improved.

2. In the autonomous work machine according to the above embodiments,
the control means changes the travel route so that the autonomous work machine executes work again on the rear work target object.

As a result, rework can be automatically executed according to a state of a work target object.

3. In the autonomous work machine according to the above embodiments,
the control means changes the travel route by moving the autonomous work machine backward.

As a result, it is possible to execute rework while moving backward, so that work on a work target object can be redone more smoothly and quickly.

4. In the autonomous work machine according to the above embodiments,
the control means changes the travel route so that the autonomous work machine works on a work target object in a worked area (701) including at least a part of the rear work target object and a work target object in an unworked area (an area outside of 701) where the autonomous work machine is not performing work.

As a result, rework is performed in a slightly shifted state instead of performing rework in the exactly the same travel route last time, so that a possibility that the work that has been insufficient last time can be sufficiently executed this time can be increased. For example, it is possible to eliminate work unevenness and the like caused by stepping down due to wheels of a work vehicle by the rework.

5. In the autonomous work machine according to the above embodiments,
the control means changes the travel route by shifting a position of the autonomous work machine in a lateral direction by a predetermined amount and moving the autonomous work machine backward.

As a result, rework is performed in a slightly shifted state instead of performing rework in the exactly the same travel route last time, so that a possibility that the work that has been insufficient last time can be sufficiently executed this time can be increased. For example, it is possible to eliminate work unevenness and the like caused by stepping down due to wheels of a work vehicle by the rework.

6. In the autonomous work machine according to the above embodiments,
the work target object is vegetation (such as a lawn), and
the working means is cutting means (20) for cutting the vegetation.

As a result, it is possible to perform work of cutting vegetation.

7. In the autonomous work machine according to the above embodiments,
the detection means detects a height of the vegetation.

As a result, for example, the travel route of the work machine can be controlled according to uniformity of the height of the vegetation.

8. In the autonomous work machine according to the above embodiments,
the detection means is photographing means (17), and
   the determination means determines a state of the rear work target object by comparing a teacher image (601) in which the vegetation has a specific height with a photographed image (602) obtained by photographing the rear vegetation by the photographing means.

As a result, it is possible to determine the state of the vegetation from the photographed image.

9. In the autonomous work machine according to the above embodiments,
the determination means determines a degree of non-uniformity of the rear work target object by comparing the teacher image with the photographed image.

As a result, it is possible to determine whether the rear work target object is uniformly worked or non-uniformly worked.

10. In the autonomous work machine according to the above embodiments,
the determination means determines the state of the rear work target object by comparing distribution of luminance values between the teacher image and the photographed image.

As a result, it is possible to determine whether the work is successfully executed from a difference in the luminance distribution from an ideal teacher image.

11. In the autonomous work machine according to the above embodiments,
the detection means is laser irradiation means (18), and
   the laser irradiation means irradiates rear vegetation of the autonomous work machine with a laser.

As a result, the vegetation can be detected.

12. In the autonomous work machine according to the above embodiments,
the laser irradiation means scans the laser in a horizontal direction.

As a result, it is possible to accurately detect a height of the vegetation in the horizontal direction.

13. In the autonomous work machine according to the above embodiments,
an irradiation range of the laser is wider than a size of the cutting means.

As a result, it is possible to more reliably detect a range including the cut vegetation.

14. The autonomous work machine according to the above embodiments, further comprising:
estimation means (48, 44) for estimating a position of the autonomous work machine, wherein the travel route is controlled based on a position of the autonomous work machine at the time of detection by the detection means and a position of the rear work target object.

As a result, the work vehicle 10 can travel with higher accuracy, so that rework can be executed with high accuracy.

15. The autonomous work machine according to the above embodiments, further comprising:
notification means (35, 44b) for notifying a communication device (350) of information, wherein
   the detection means further detects a work target object after rework by the autonomous work machine in accordance with a change in the travel route,
   the determination means further determines a state of the work target object after the rework, and the notification means determines necessity of notification to the communication device based on the state of the work target object after the rework, and notifies the communication device of information when it is determined that notification is necessary.

As a result, it is possible to improve a situation in a case where a determination result is not improved even by rework.

16. In the autonomous work machine according to the above embodiments,
the notification means determines that notification is necessary when the work target object after the rework is non-uniform, and notifies the communication device of information indicating that manual work is necessary or information indicating that replacement of the working means is necessary.

As a result, a user can recognize what kind of measure should be specifically taken.

17. The autonomous work machine according to the above embodiments is an autonomous work machine (10) including working means (20), the autonomous work machine comprising:
detection means (17, 18, 44) for detecting a rear work target object of the autonomous work machine;
transmission means (44) for transmitting a detection result of the detection means to an information processing device (350);
receiving means (44) for receiving, from the information processing device, a determination result of a state of the rear work target object based on the detection result; and
control means (44) for controlling a travel route of the autonomous work machine based on the determination result.

As a result, it is possible to perform control such that work is continued when the rear work target object is sufficiently worked, and the work is returned and rework is performed when the work is insufficient. As described above, by controlling the travel route according to the state of the work target object, it is possible to redo the work on the work target object by one work machine. Therefore, it is not necessary to use another type of work machine, and work efficiency can be improved. Furthermore, since a part of the processing is executed by another device (such as a server device), a processing load on the work machine can be reduced.

18. The control method of an autonomous work machine according to the above embodiments is a control method of an autonomous work machine (10) including working means (20), the control method comprising:
a detection step of detecting a rear work target object of the autonomous work machine;
a determination step of determining a state of the rear work target object based on a detection result by the detection step; and
a control step of controlling a travel route of the autonomous work machine based on a determination result by the determination step.

As a result, it is possible to perform control such that work is continued when the rear work target object is sufficiently worked, and the work is returned and rework is performed when the work is insufficient. As described above, by controlling the travel route according to the state of the work target object, it is possible to redo the work on the work target object by one work machine. Therefore, it is not necessary to use another type of work machine, and work efficiency can be improved.

19. The control method of an autonomous work machine according to the above embodiments is a control method of an autonomous work machine (10) including working means (20), the control method comprising:
a detection step of detecting a rear work target object of the autonomous work machine;
a transmission step of transmitting a detection result by the detection step to an information processing device;
a receiving step of receiving, from the information processing device, a determination result of a state of the rear work target object based on the detection result; and
a control step of controlling a travel route of the autonomous work machine based on the determination result.

As a result, it is possible to perform control such that work is continued when the rear work target object is sufficiently worked, and the work is returned and rework is performed when the work is insufficient. As described above, by controlling the travel route according to the state of the work target object, it is possible to redo the work on the work target object by one work machine. Therefore, it is not necessary to use another type of work machine, and work efficiency can be improved. Furthermore, since a part of the processing is executed by another device (such as a server device), a processing load on the work machine can be reduced.

20. The program according to the above embodiments is a program for causing a computer to execute the control method of an autonomous work.

As a result, the control method of an autonomous work machine can be realized by the computer.

21. The storage medium according to the above embodiments is a storage medium storing a program.

As a result, it is possible to realize the present invention as the storage medium.

### Other Embodiments

In addition, a program for realizing one or more functions that have been described in each of the embodiments is supplied to a system or a device through a network or via a storage medium, and one or more processors (or controllers) on a computer of the system or the device are capable of reading and executing the program. The present invention can also be realized in such an aspect.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. An autonomous work machine including a working unit, the autonomous work machine comprising:
a detection unit configured to detect a rear work target object of the autonomous work machine;
a determination unit configured to determine a state of the rear work target object based on a detection result of the detection unit; and
a control unit configured to control a travel route of the autonomous work machine based on a determination result of the determination unit.

2. The autonomous work machine according to claim 1, wherein the control unit changes the travel route so that the autonomous work machine executes work again on the rear work target object.

3. The autonomous work machine according to claim 1, wherein the control unit changes the travel route by moving the autonomous work machine backward.

4. The autonomous work machine according to claim 1, wherein the control unit changes the travel route so that the autonomous work machine works on a work target object in a worked area including at least a part of the rear work target object and a work target object in an unworked area where the autonomous work machine is not performing work.

5. The autonomous work machine according to claim 1, wherein the control unit changes the travel route by shifting a position of the autonomous work machine in a lateral direction by a predetermined amount and moving the autonomous work machine backward.

6. The autonomous work machine according to claim 1, wherein
the work target object is vegetation, and
the working unit is a cutting unit configured to cut the vegetation.

7. The autonomous work machine according to claim 6, wherein the detection unit detects a height of the vegetation.

8. The autonomous work machine according to claim 6, wherein
the detection unit is a photographing unit, and
the determination unit determines a state of the rear work target object by comparing a teacher image in which the vegetation has a specific height with a photographed image obtained by photographing a rear vegetation by the photographing unit.

9. The autonomous work machine according to claim 8, wherein the determination unit determines a degree of non-uniformity of the rear work target object by comparing the teacher image with the photographed image.

10. The autonomous work machine according to claim 8, wherein the determination unit determines the state of the rear work target object by comparing distribution of luminance values between the teacher image and the photographed image.

11. The autonomous work machine according to claim 6, wherein
the detection unit is a laser irradiation unit, and
the laser irradiation unit irradiates rear vegetation of the autonomous work machine with a laser.

12. The autonomous work machine according to claim 11, wherein the laser irradiation unit scans the laser in a horizontal direction.

13. The autonomous work machine according to claim 11, wherein an irradiation range of the laser is wider than a size of the cutting unit.

14. The autonomous work machine according to claim 1, further comprising:
an estimation unit configured to estimate a position of the autonomous work machine, wherein the control unit controls the travel route based on a position of the autonomous work machine at the time of detection by the detection unit and a position of the rear work target object.

15. The autonomous work machine according to claim 1, further comprising:
a notification unit configured to notify a communication device of information, wherein
the detection unit further detects a work target object after rework by the autonomous work machine in accordance with a change in the travel route,
the determination unit further determines a state of the work target objectwork target object after the rework, and
the notification unit determines necessity of notification to the communication device based on the state of the work target objectwork target object after the rework, and notifies the communication device of information when it is determined that notification is necessary.

16. The autonomous work machine according to claim 15, wherein the notification unit determines that notification is necessary when the work target object after the rework is non-uniform, and notifies the communication device of information indicating that manual work is necessary or information indicating that replacement of the working unit is necessary.

17. An autonomous work machine including a working unit, the autonomous work machine comprising:
a detection unit configured to detect a rear work target object of the autonomous work machine;
a transmission unit configured to transmit a detection result of the detection unit to an information processing device;
a receiving unit configured to receive, from the information processing device, a determination result of a state of the rear work target object based on the detection result; and
a control unit configured to control a travel route of the autonomous work machine based on the determination result.

18. A control method of an autonomous work machine including a working unit, the control method comprising:
detecting a rear work target object of the autonomous work machine;
determining a state of the rear work target object based on a detection result in the detecting; and
controlling a travel route of the autonomous work machine based on a determination result in the determining.

19. A control method of an autonomous work machine including a working unit, the control method comprising:
detecting a rear work target object of the autonomous work machine;
transmitting a detection result in the detecting to an information processing device;
receiving, from the information processing device, a determination result of a state of the rear work target object based on the detection result; and
controlling a travel route of the autonomous work machine based on the determination result.

20. A non-transitory computer readable storage medium storing a program for causing a computer to execute a control method of an autonomous work machine including a working unit, the control method comprising:
detecting a rear work target object of the autonomous work machine;
determining a state of the rear work target object based on a detection result in the detecting; and
controlling a travel route of the autonomous work machine based on a determination result in the determining.

21. A non-transitory computer readable storage medium storing a program for causing a computer to execute a control method of an autonomous work machine including a working unit, the control method comprising:
detecting a rear work target object of the autonomous work machine;
transmitting a detection result in the detecting to an information processing device;
receiving, from the information processing device, a determination result of a state of the rear work target object based on the detection result; and
controlling a travel route of the autonomous work machine based on the determination result.
